(19) United States
(12) Patent Application Publication
(10) Pub. No.: US 2008/0158242 A1
(43) Pub. Date: Jul. 3, 2008

(54) VIRTUAL IMAGE PRESERVATION

(76) Inventor: Kimberly St. Jacques, Fairport, NY (US)

Correspondence Address: JAECKLE FLEISCHMANN & MUGEL, LLP, 190 Linden Oaks, ROCHESTER, NY, 14625-2812, US

(21) Appl. No.: 11/968,762

(22) Filed: Jan. 3, 2008

Related U.S. Application Data
(60) Provisional application No. 60/883,270, filed on Jan. 3, 2007.

(51) Int. Cl. G09G 5/02; G06T 15/00; G09G 5/00; H04N 5/225

(52) U.S. Cl. 345/589; 345/419; 345/642; 348/207.99

(57) ABSTRACT

A method of preserving a memory within a virtual environment is disclosed. The method includes the steps of entering the virtual environment, viewing a virtual scene in the virtual environment, and capturing at least a portion of the virtual scene from within the virtual environment. A virtual image preservation system is also disclosed. The virtual image preservation system includes a virtual imaging processor configured to create a virtual environment. The virtual image preservation system also includes a controller coupled to the virtual imaging processor. The virtual imaging processor is configured to allow a user to capture a virtual scene from within the virtual environment. A method for fulfilling virtual images is further disclosed. The method includes capturing an image from within a virtual environment, accessing a virtual image fulfillment center, and generating an output version of the captured image.

### CROSS-REFERENCE TO RELATED APPLICATIONS

This application claims the benefit of U.S. Provisional Patent Application No. 60/883,270, filed on Jan. 3, 2007.

### BACKGROUND OF THE INVENTION

The present invention generally relates to virtual systems, and more specifically to systems and methods for capturing and fulfilling images from virtual environments.

Increasingly more powerful processing devices, coupled with ever-improving software and programming are enabling people to interact with realistic virtual environments on a daily basis. Often, this interaction takes the form of a video game in which a person effectively moves around a virtual world while playing the game. The person controls and moves through the game using a game controller, such as a joystick, a keypad, a mouse, a motion or pressure sensitive device, or any combination thereof. Visual feedback is provided to the user via a television screen, monitor, virtual-reality headset, or any combination thereof. Many times, the game processors are capable of linking together players from multiple locations, placing their characters within the same virtual environment for virtual interaction with each other.

In many of the virtual roll-playing scenarios or games, the people playing the game form relationships with their virtual friends over the course of working together to complete the challenges of the game. While this friendship aspect mirrors the real world, those people interacting with virtual environments do not have the chance to preserve memories from the virtual environment like people do in the real world. The best solutions to-date for trying to preserve such memories are a print screen or screen capture when viewing the virtual environment on a flat screen. This is limited in its functionality, especially in that the process of printing or capturing the screen does not interact with the virtual world, so some of the feeling of virtual reality can be lost. Furthermore, since the virtual world is an interactive world, the virtual friends do not get to know what is happening when someone is performing a print screen, and therefore do not have a way of knowing that their picture is being taken.

Therefore, it would be desirable to have a system and method for preserving virtual images which allows a person to remain in the virtual environment while capturing and possibly fulfilling virtual images.

### BRIEF SUMMARY OF THE INVENTION

In accordance with an aspect of the present invention, a method of preserving a memory within a virtual environment is disclosed. In particular, the method includes entering virtual environment, viewing a virtual scene in the virtual environment, and capturing at least a portion of the virtual scene from within the virtual environment.

A virtual image preservation system is also disclosed. The virtual image preservation system includes a virtual imaging processor configured to create a virtual environment. The virtual image preservation system also includes a controller coupled to the virtual imaging processor. The virtual imaging processor is configured to allow a user to capture a virtual scene from within the virtual environment.

A method for fulfilling virtual images is further disclosed. In particular, the method includes capturing an image from within a virtual environment, accessing a virtual image fulfillment center, and generating an output version of the captured image.

### BRIEF DESCRIPTION OF THE DRAWINGS

The above-mentioned and other features and advantages of this invention, and the manner of attaining them, will become appreciated and be more readily understood by reference to the following detailed description of one embodiment of the invention in conjunction with the accompanying drawings, wherein:

FIG. 1 schematically illustrates an embodiment of a virtual image preservation system;

FIG. 2 illustrates one embodiment of a method of preserving a memory within a virtual environment;

FIGS. 3A-3E schematically illustrate embodiments of capturing at least a portion of a virtual scene;

FIGS. 4A-4B schematically illustrate embodiments of capturing at least a portion of a virtual scene;

FIG. 5 schematically illustrates an embodiment of a virtual image preservation system; and

FIG. 6 illustrates one embodiment of a method of fulfilling virtual images.

### DETAILED DESCRIPTION OF THE INVENTION

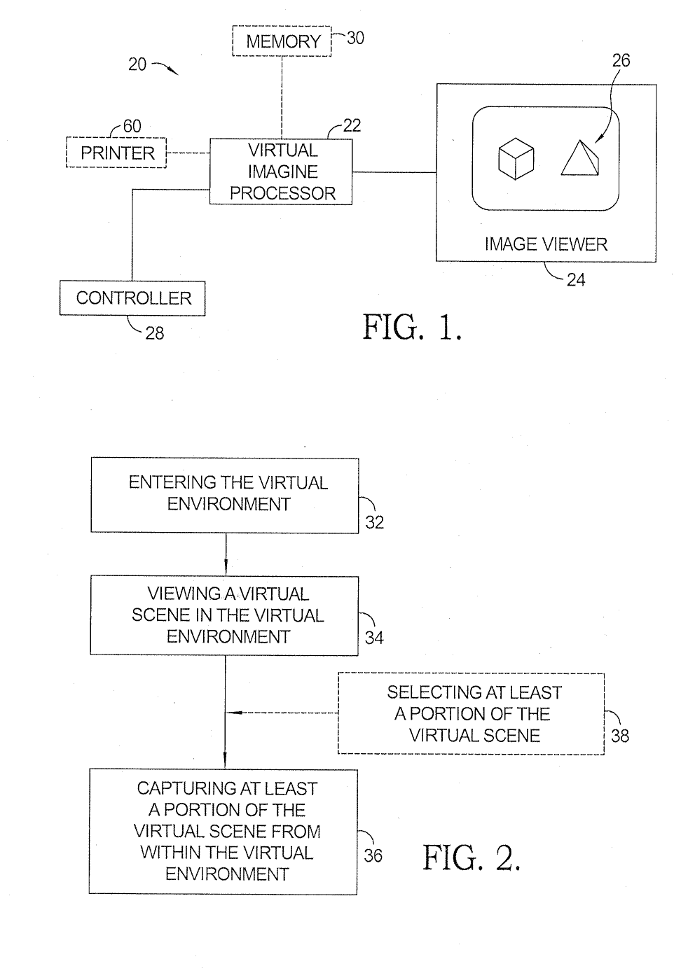

People who use software and systems allowing them to participate in virtual activities are not currently provided with a service to preserve virtual images. FIG. 1 schematically illustrates one embodiment of a virtual image preservation system 20. Virtual imaging processor 22 is the heart of the system 20. Virtual imaging processor 22 is configured to be able to generate a virtual world within which a user can interact. Examples of possible virtual worlds include, but are not limited to, video games, flight simulators, combat simulators, role playing adventures, training simulators, and education simulations. The virtual imaging processor 22 generates the graphics necessary to create the virtual world. Virtual imaging processor 22 is shown generically in FIG. 1 for simplicity, but the processor 22 can be a computer, a game player, an application specific integrated circuit (ASIC), digital components, analog components, or any combination thereof. The virtual imaging processor 22 can also be a single device or a plurality of distributed devices which are locally or remotely networked.

The virtual imaging processor 22 is coupled to an image viewer 24. Image viewer 24 makes it possible for one or more users to experience a virtual world 26. Although the image viewer 24 schematically resembles a television display, there can be many other types of image viewers 24, such as projectors, displays, imaging glasses worn by a user, helmets, and goggles. Other embodiments of virtual imaging preservation systems may contain a plurality of image viewers 24, for example, a flight simulator which has separate image viewers for each of an airplane cockpit's windows. Although a simplistic virtual world 26 is illustrated in the schematic drawings, it should be understood that virtual worlds 26 may be much more detailed and/or realistic in practice. Virtual worlds 26 can appear two dimensional or three dimensional and can vary with time.

A controller 28 may also be coupled to the virtual imaging processor 22. While the image viewer 24 is on the output side of the virtual imaging system 20, the controller 28 is on the input side of the system 20. The controller 28 allows the user to provide input to the virtual imaging processor 22 which the processor 22 can then use, at least in part, to update the image viewer 24. For example, the controller 28 can indicate the users body position, movement, desired direction of movement, desired actions, or provide text and/or audio or video input to the processor 22. Real-world examples of controllers 28 can include pressure sensing devices, movement sensing devices, game controllers, joy sticks, pedals, steering wheels, firearms or firearm-like devices, helmets, clothing, keyboards, mice, microphones, and/or any combination thereof.

The virtual imaging system 20 may also have one or more removable memories 30. While the virtual imaging processor 22 can have its own non-removable memory in some embodiments, other embodiments may also or alternately have a removable memory 30. Memory 30 can be used to store all or some of the program instructions and/or data for the virtual world 26.

Although the components of FIG. 1 are illustrated as being coupled by lines, the actual couplings can be wired, wireless, or any combination thereof, depending on the embodiment. Given the large number of systems which could be virtual imaging systems 20, the remainder of the specification will often only refer to a video game environment for convenience and simplicity, since that virtual environment has a high probability of being the virtual environment with which most people are familiar. It should be understood, however, that there are many other types of virtual imaging systems, as explained above.

In order to preserve a memory within the virtual environment provided by the virtual imaging system 20, a user can follow a prescribed embodiment of actions. FIG. 2 illustrates one embodiment of actions for preserving a memory within a virtual environment. A user must first enter 32 the virtual environment. There are many ways to enter 32 the virtual environment. One example of entering 32 an environment is by using the controller 28 to provide input to the virtual imaging processor for the purpose of selecting, manipulating, moving or just letting the processor know where you are within the virtual environment. Entering the virtual environment involves a participation in the environment, even if it is just to provide your location within the environment. After entering 32 the virtual environment, a user can then view 34 a virtual scene within the virtual environment. This includes receiving visual feedback via the image viewer 24, whereby the virtual environment 26 can be viewed. Finally, at least a portion of the virtual scene is captured 36 from within the virtual environment. In some embodiments, the capturing 36 action also includes a selecting action whereby at least a portion of the virtual scene is selected 38. The selection and capturing process occurs within the virtual environment, as opposed to a simple screen capture which can be done without entering the virtual environment.

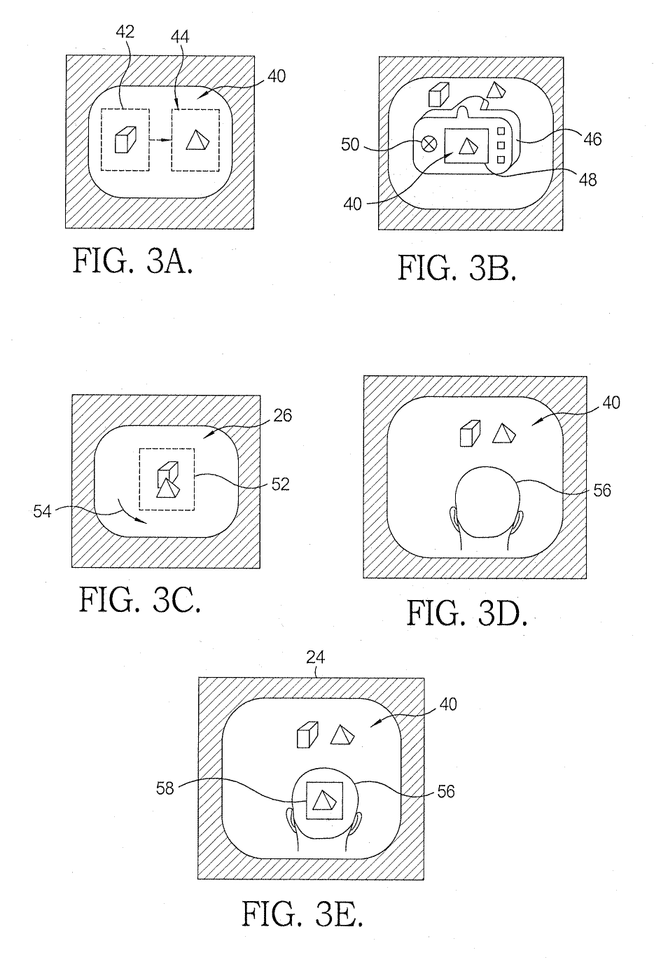

The selection and/or capture process can occur in a variety of ways. FIGS. 3A-3E schematically illustrate embodiments of capturing at least a portion of a virtual scene 40. In one embodiment, as part of the selecting and/or capturing process, the user can be presented with a selection template 42. The template 42 can be moved to a desired location 44. Whatever portion of scene 40 is viewable within the template will be the captured scene when the user indicates a capture should occur, for example, by pressing a button on the controller 28. Since the user has entered the virtual environment prior to using the template, the user can move within the environment and then move the template independently of the user's movement within the environment, or the user's movement can be linked to the movement of the template. A real world analogy which helps to understand the difference between these two embodiments is to imagine a person outside with a camera. In the first case, the person holds their camera at their side and walks around until they see something they want to capture. Because they were carrying their camera, it moved with them, but because they were not looking through the camera, it is not necessarily pointing at the scene they want to capture. The person must then look through the camera viewfinder (similar to the template in the virtual world) and position the camera before taking the picture. In the second case, the person is holding the camera up and looking through the viewfinder as they move around outside. When they see the scene they want, they are already looking at the scene because the viewfinder (like the template in our example) was moving with them from their point of view. In this case, the picture can be taken immediately upon seeing a desired scene.

In a different, but related embodiment of FIG. 3B, a virtual camera 46 can be provided by the virtual imaging processor 22 within the virtual environment. The virtual camera 46 can have a viewfinder 48 which shows virtual scenes 40 which can be captured. Since the user is within the virtual world, they can move the camera within the virtual world, pointing it where they like until they find a scene which they would like to capture. The virtual environment can still be viewed around the virtual camera 46 just as if the user was in the real world with a real camera. The virtual camera may also provide controls 50 (visible or not) for zooming in on the image, applying filters, black and white effects, sepia effects, etc. When a desired scene is found on the virtual camera viewfinder 48, then the user can capture the picture by indicating that a capture should occur with the controller.

Although the embodiments thus far have discussed capturing at least a portion of the virtual scene with regard to a camera and still shots, it should also be understood that the image capturing can also occur as a video. Since the virtual world is a changing world, the ability to capture video of at least a portion of the environment may be attractive to those wishing to preserve memories of that environment, just as it is in the real world. In video-based embodiments, the template or camera interface, when activated, could record a certain number of frames per minute, at a particular resolution to record a video of the desired scene. The user could also move the template around or move within the virtual environment to be able to change the view-point of the video. Zoom and image editing features, similar to those discussed above could also be implemented. FIG. 3C schematically illustrates a template 52 being used for preserving a video of at least a portion of a virtual environment 26 while the person who has entered the virtual world is moving 54 through the virtual world.

FIG. 3D illustrates yet another possible embodiment of capturing at least a portion of a virtual scene 40. In some virtual worlds, when a person enters the virtual world, they can see at least some of their virtual self. This is schematically illustrated by the head 56 in FIG. 3D. In other embodiments, the view could be through goggles or glasses. In further embodiments, the view could show an entire person, or a different portion of a virtual person, such as one or more arms or hands. As the person moves through the virtual world in this type of embodiment, whatever virtual scene 40 their character is looking at can be the selected scene for when the user uses the controller 28 to indicate that they want to capture the scene. The scene capture would not show the head 56 or other part of the person if so desired. The virtual imaging processor 22 can be set-up to capture the scene which is before the virtual person without the reference head in the picture, similar to the virtual camera embodiment in FIG. 3B. In other embodiments, such as the embodiment of FIG. 3E, the concepts of the embodiments of FIGS. 3B and 3D can be combined by providing a viewfinder area 58 on the image viewer 24 which shows where the virtual person 56 is looking. As the person 56 moves through the virtual world, the image in the viewfinder area 58 will change accordingly.

All images, whether still photos or videos, captured in the virtual environment can be stored on a memory in the virtual imaging processor 22. This can be an internal memory or an external or removable memory 30, such as the memory illustrated in FIG. 1. Examples of suitable memories include, but are not limited to random access memory (RAM), non-volatile memory (NVM), magnetic media, and optical media.

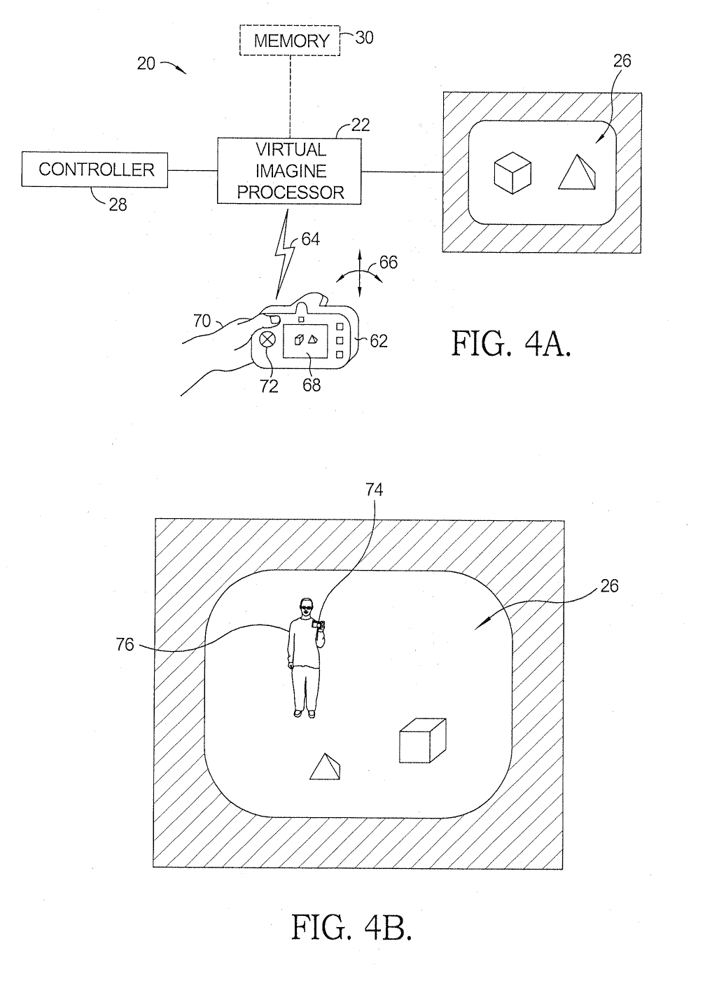

FIGS. 4A-4B schematically illustrate further embodiments of capturing at least a portion of a virtual scene. The embodiment of FIG. 4A provides an alternative mechanism by which a user can enter the virtual environment, view a virtual scene within the virtual environment, and capture at least a portion of the virtual scene from within the virtual environment. In this instance, the user has a camera 62 in the real world which is coupled 64 to the virtual imaging processor 22. The coupling 64 can be direct wired by electric or optical cable or wireless, either by radio frequency (RF) technology or by an optical link. The camera 62 can be equipped with motion sensors, such as accelerometers, which can detect and quantify the movement 66 of the camera. Many cameras are already equipped with similar motion sensing capabilities for jitter correction. The motion of the camera 62 can be conveyed to the virtual imaging processor by the coupling 64. The camera 62 can be in addition to another controller 28, or it can operate as its own controller.

As described previously, the virtual imaging processor 22 generates a virtual environment 26. After the camera 62 couples to the virtual imaging processor 22, the user can enter the virtual environment by the processor 22 assigning a starting position within the environment 26 to the camera 62. This starting position may or may not correspond to a view or position shown on an image viewer 24 which may also be coupled to the virtual imaging processor 22. Based on the starting position assigned to the camera 62 by the processor 22, the processor 22 sends image data to the camera 62 which can be viewed on a viewfinder 68. The viewfinder 68 can be a liquid crystal display (LCD) which can be seen while holding the camera away from the user's eye, or the viewfinder 68 can be a window on the camera 62 which the user must hold their eye close-to in order to see an image. For simplicity, the viewfinder 68 is illustrated here as an LCD screen. By sending image data to the real camera 62, a user can see a view of the virtual world 26 that they have entered which corresponds to what the camera 62 is pointing to in the virtual world.

As the user 70 moves the camera 62, the motion 66 of the camera is captured and sent to the virtual imaging processor 22. The processor 22 can translate the real world motion into virtual world motion and send updated display information to the camera which corresponds to what the camera would then be pointing to in the virtual world had the motion of the camera taken place in the virtual world. In some embodiments, the camera 62 can also be a real-world camera which happens to have a virtual mode when coupled to the virtual imaging processor 22. In other embodiments, the camera 62 may not function to capture real world images, but rather can only capture images from the virtual world. In further embodiments, the camera 62 may be equipped with controls 72 for adjusting the zoom of the virtual scene or other image quality parameters. In the example of a zoom feature, when the camera 62 wants to zoom in on a scene, that magnification can happen either locally on-board the camera with pixel manipulation, or a zoom request can be sent to the virtual imaging processor 22 for the purpose of instructing the processor 22 to provide a magnified image to the camera 62.

When it the user 70 sees an image on the viewfinder 68 which they would like to capture, they can press a shutter button on the camera to effect the capture. The image can then be stored on a memory in the camera, or the image can be stored on a memory in the virtual imaging processor 22. In order to store the image on the processor 22, the camera 62 can either send a capture signal to the processor 22 telling it to capture the currently communicated image, or the camera could send a copy of the captured image to the processor. The latter situation could be especially useful when the camera has performed local image manipulations, such as zooming, that the processor did not know about.

As FIG. 4B schematically illustrates, in some embodiments, the position information of the camera 62 can be used to show a virtual representation 74 of the camera 62 within the virtual environment 26. This may not be especially useful to the user of the camera 62, but in virtual environments where people from different locations are participating in the virtual environment, it could be beneficial for them to be able to see when a person is taking their virtual picture. In this case, the virtual imaging processor 22 can generate a virtual depiction of the camera 74 as held by the virtual user 76 within the virtual environment 26. Such a feature would add realism to the virtual world and help all the participants of the virtual world be able to enjoy the memory preservation process similar to how it can be done in the real world.

It should be noted that the camera 62 in the embodiments discussed above could alternatively or additionally be a video camera rather than just a still camera.

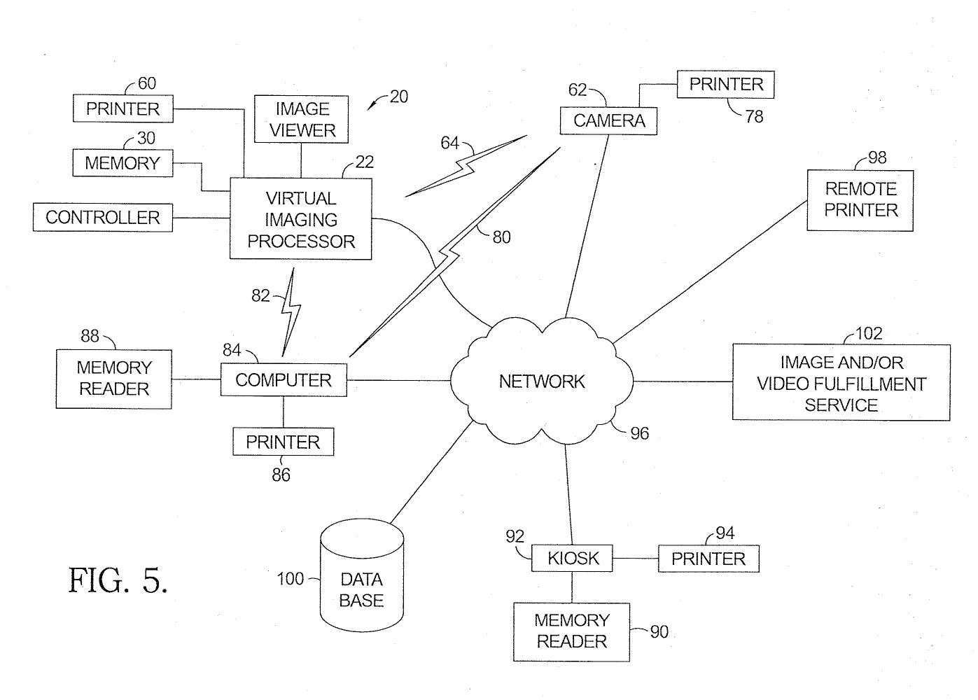

FIG. 5 schematically illustrates an embodiment of a virtual image preservation system 20 as it relates to the image fulfillment options which may be available with such a system. From the descriptions above, a virtual image may be preserved within a virtual environment in many ways. The end result of the image capturing process is that the image is stored on a memory. The memory can be inherent to the virtual imaging processor 22. Optionally, the memory can be removably attached 30 to the virtual imaging processor 22. The memory could even be inherent to or removably attached to the camera 62. In some embodiments, a printer 60, coupled to the virtual imaging processor 22 can be used to fulfill the captured virtual image by printing a hardcopy of the photograph. In other embodiments, a printer 78 coupled to the camera 62 may be used to fulfill the captured virtual image by printing a hardcopy of the photograph. The camera 62 can be coupled 64 to the virtual imaging processor 22, so any image stored on the camera 62 could be sent to the virtual imaging processor 22 for printing on printer 60. Similarly, any image stored on the virtual imaging processor 22 could be sent to the camera 62 for printing on the printer 78.

The camera 62 and/or the virtual imaging processor 22 may also be coupled 80, 82 to an external computer 84. External computer 84 may have a printer 86 coupled to it. Images stored on the virtual imaging processor 22 can be sent to the printer 86 via coupling 82 and computer 84 for fulfillment by printing a hardcopy of the photograph. Similarly, images stored on the camera 62 can be sent to the printer 86 via coupling 80 and computer 84 for fulfillment by printing a hardcopy of the photograph.

In other embodiments, if the captured virtual scene is stored on a removable memory, the removable memory 30 can be uncoupled from the virtual imaging processor 22 or the camera 62 and coupled to a memory reader 88 which is coupled to the external computer 84. Images readable from memory reader 88 can be fulfilled by printing hardcopies of photographs on printer 86. Alternatively, the removable memory 30 can be coupled to a memory reader 90 at a kiosk 92. The kiosk 92 may offer image services, such as cropping, resizing, rotating, color filters, etc. Images read from memory reader 90 can then be fulfilled by printing hard copies of the photographs on printer 94.

In other embodiments, the virtual imaging processor 22, the camera 62, the external computer 84, and/or the kiosk 92 may be connected to a network 96. In this type of embodiment, these devices can send their captured images to a remote printer 98 for fulfillment as hardcopy prints, or to a database 100 for storage. In some embodiments, the captured images may be sent to an image and/or video fulfillment service 102. Up to this point, fulfillment of the captured images has been discussed in terms of printing hardcopies of the photographs, but there are other types of fulfillment possible for the images. The fulfillment service 102 can produce prints of the image not only on paper, but also on items such as t-shirts and mugs. When the captured images are video data, the fulfillment service 102 can alternatively produce DVD's or video tapes from the data.

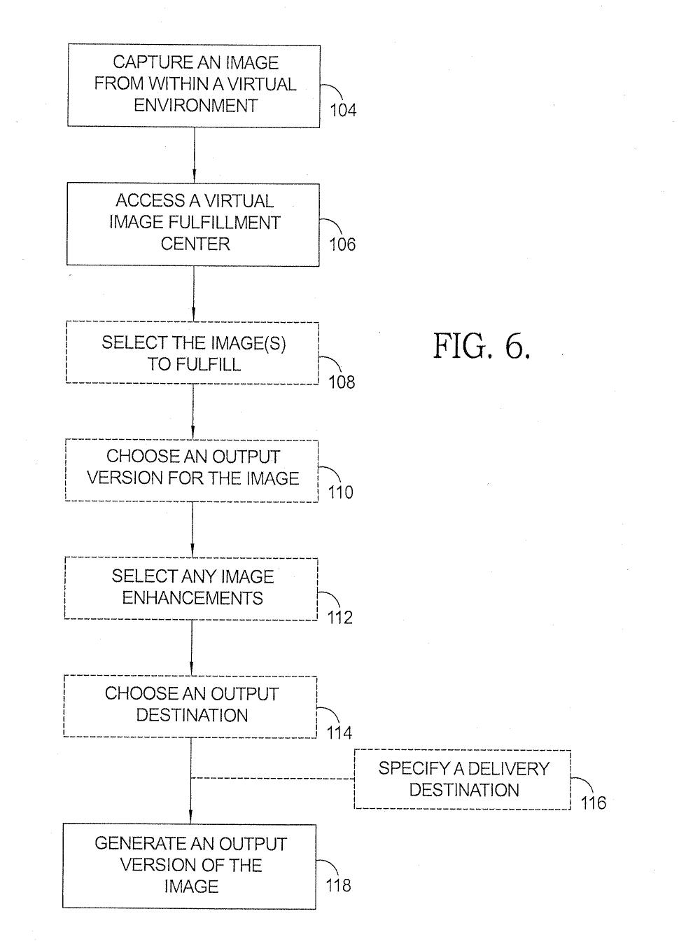

FIG. 6 illustrates one embodiment of a method of fulfilling virtual images. First, at least one image is captured 104 from within a virtual environment. Suitable methods and systems for doing this have been discussed with regard to the embodiments above and their equivalents. Then, within the virtual environment, the user can go to or otherwise access a virtual image fulfillment center 106. In the video game world, the virtual image fulfillment center could be a virtual depiction of a kiosk or a printing business staffed by virtual employees or machines. Optionally, the user can select 108 the image(s) she would like to fulfill. If this step is not used, then a default number of images, such as all of the images stored on a particular memory could be selected automatically. Alternatively, the last captured image could be selected by itself as a default. Optionally, the user can choose 110 an output version for the image. There are many possible output versions, such as hardcopy photographs, pictures on mugs, pictures, on t-shirts, posters, video tapes, and DVD's. If this step is not used, then a default output version, such as a hardcopy photograph for still images or a DVD for video images could be used. Optionally, the user could select 112 any desired image enhancements, such as cropping, rotating, hue adjustment, resizing, or image filtering which either the virtual imaging processor and/or the ultimate fulfillment destination can provide. Again, if this step is not used, then default image enhancements, or a lack thereof, could apply. Optionally, the user can select 114 an output destination. The output destination is the real world device or service which is able to fulfill the image as desired. For example, if the chosen or default output version for an image is a hardcopy photograph, then the user might be able to choose between a local printer, a remote printer, and/or a fulfillment service provider. If this step is not used, then default output destinations for each type of output version could apply. Optionally, the user could specify 116 a delivery destination for the fulfilled image. For example, if a fulfillment service provider who can print images on t-shirts is selected in a previous step, a delivery address could be provided in this step so that the user can receive the mug or have the mug sent to a third-party (e.g., friend) as a gift. Once all of the selections have been made, either by choice, or by default, then an output version of the image can be generated 118. This is a valuable service to those participating in virtual environments which is currently lacking. It enhances the enjoyment of the virtual friendships and accomplishments which are made in virtual environments, such as online gaming environments.

The aforementioned embodiments of a virtual image preservation system and methods of preserving a memory within a virtual environment enable people, such as on-line gamers, to take virtual photos and/or videos and fulfill them in the real world.

Having thus described several embodiments of the claimed invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and the scope of the claimed invention. Additionally, the recited order of the processing elements or sequences, or the use of numbers, letters, or other designations therefore, is not intended to limit the claimed processes to any order except as may be specified in the claims. Accordingly, the claimed invention is limited only by the following claims and equivalents thereto.

What is claimed is:

1. A method of preserving a memory within a virtual environment, comprising:
entering the virtual environment;
viewing a virtual scene in the virtual environment; and
capturing at least a portion of the virtual scene from within the virtual environment.

2. The method of claim 1, wherein the virtual environment comprises a video game.

3. The method of claim 1, wherein capturing at least a portion of the virtual scene comprises taking a virtual picture of at least a portion of the virtual scene.

4. The method of claim 3, wherein taking a virtual picture of at least a portion of the virtual scene comprises selecting the portion of the virtual scene prior to taking the virtual picture.

5. The method of claim 4, wherein selecting the portion of the virtual scene comprises moving a virtual camera within the virtual environment.

6. The method of claim 1, further comprising fulfilling the captured virtual scene.

7. The method of claim 6, wherein fulfilling the captured virtual scene is selected from the group consisting of:
printing a hardcopy of the captured virtual scene;
creating a mug with a picture of the captured virtual scene on it;
creating a t-shirt with a picture of the captured virtual scene on it;
creating a video tape with a video of the captured virtual scene on it; and
creating a DVD with a video of the captured virtual scene on it.

8. A virtual image preservation system, comprising:
a virtual imaging processor configured to create a virtual environment;
a controller coupled to the virtual imaging processor; and
wherein the virtual imaging processor is configured to allow a user to capture a virtual scene from within the virtual environment.

9. The virtual image preservation system of claim 8, further comprising an image viewer, wherein the virtual imaging processor can display at least a portion of the virtual environment on the image viewer to facilitate the user's capture of the virtual scene from within the virtual environment.

10. The virtual image preservation system of claim 9, wherein the virtual imaging processor is further configured to provide a template visible on the image viewer which the user can manipulate with the controller to indicate to the virtual imaging processor where it should capture the virtual scene.

11. The virtual image preservation system of claim 9, wherein the virtual imaging processor is further configured to provide a virtual camera visible on the image viewer which the user can manipulate with the controller to indicate to the virtual imaging processor where it should capture the virtual scene.

12. The virtual image preservation system if claim 11, wherein the virtual camera has a viewfinder.

13. The virtual image preservation system of claim 8, further comprising a camera coupled to the virtual imaging processor.

14. The virtual image preservation system of claim 13, wherein the camera comprises a camera which can also capture images of the real world.

15. The virtual image preservation system of claim 8, wherein the virtual imaging processor is further configured to be connected to a printer.

16. The virtual image preservation system of claim 8, wherein the virtual imaging processor is configured to send the captured virtual scene to a fulfillment device selected from the group consisting of: a remote printer, a local printer, an image fulfillment service, a video fulfillment service, a kiosk, a database, and an external computer.

17. A method for fulfilling virtual images, comprising:
capturing an image from within a virtual environment;
accessing a virtual image fulfillment center; and
generating an output version of the captured image.

18. The method of claim 17, further comprising selecting at least one captured image to fulfill.

19. The method of claim 17, further comprising choosing an output version for the captured image.

20. The method of claim 19, wherein the output version is selected from a group consisting of a hardcopy photograph, a picture on a mug, a picture on a t-shirt, a poster, a framed photograph, a video tape, and a DVD.

21. The method of claim 17, further comprising selecting at least one image enhancement for the captured image.

22. The method of claim 21, wherein the image enhancements are selected from the group consisting of cropping, rotating, resizing, hue shifting, and image filtering.

23. The method of claim 17, further comprising choosing an output destination.

24. The method of claim 23, wherein the output destination is selected from the group consisting of a local printer, a remote printer, a printer on coupled external computer, and a fulfillment service provider.

25. The method of claim 17, further comprising specifying a delivery destination.
